(19) United States
(12) Patent Application Publication
(10) Pub. No.: US 2025/0107527 A1
(43) Pub. Date: Apr. 3, 2025

(54) MALEIC HYDRAZIDE FOR CONTROL OF NUTSEDGE IN TURFGRASS AND ORNAMENTALS

(71) Applicant: Discovery Purchaser Corporation, New York, NY (US)

(72) Inventors: Devon Carroll, Cary, NC (US); Patrick Maxwell, Raleigh, NC (US)

(21) Appl. No.: 18/818,239

(22) Filed: Aug. 28, 2024

Related U.S. Application Data
(60) Provisional application No. 63/586,862, filed on Sep. 29, 2023.

(51) Int. Cl. A01N 43/58; A01N 61/00; A01P 13/02

(52) U.S. Cl. CPC A01N 43/58; A01N 61/00; A01P 13/02

(57) ABSTRACT

Methods and compositions for controlling undesirable vegetation in a plant growing environment are provided. The compositions may include an herbicidally effective amount of maleic hydrazide. The presently disclosed compositions may also include an herbicidal mixture of maleic hydrazide and one or more synthetic herbicides. In certain embodiments, the methods are operable to control one or more nutsedge weeds in a turfgrass system or in an ornamental plant growing environment.

### CROSS-REFERENCE TO RELATED APPLICATIONS

This application claims the benefit of priority to U.S. Provisional Application Ser. No. 63/586,862, filed Sep. 29, 2023, and titled “Maleic Hydrazide for Control of Nutsedge in Turfgrass and Ornamentals,” the entire contents of which is hereby incorporated by reference, for all purposes, in its entirety.

### TECHNICAL FIELD

The present disclosure generally relates to methods and compositions for controlling nutsedge, particularly for controlling nutsedge in turfgrass and growing environments in which ornamentals are grown.

### BACKGROUND

Nutsedges (Cyperus spp.) are the third most problematic turfgrass weed according to some estimates as a result of its common occurrence and difficulty to control or mitigate. Not surprisingly, nutsedge weeds rate highly among turfgrass growers and herbicide end-users as a weed in need of better control products and strategies. Similarly, nutsedges are ranked by ornamental plant growers and herbicide end-users as the ornamental weed most targeted by post-emergent herbicides as well as a weed requiring a better solution than those currently available. Currently available herbicides and methods of application for the post-emergence control of nutsedge typically require multiple or sequential applications and are limited by herbicidal resistance. Further, nutsedge grows via both rhizomes and tubers making it difficult to control. Accordingly, the Applicant has recognized that new compositions and methods for controlling nutsedge, particularly for the post-emergent control of nutsedge in turfgrass and ornamental plants, are desirable.

### SUMMARY

To address these shortcomings, Applicant has developed new methods and compositions for controlling hard to control undesirable vegetation, such as nutsedge, in various plant growing environments, such as turfgrass systems and ornamental plant growing environments. In particular, the presently disclosed methods involve the use of herbicidal compositions containing maleic hydrazide.

Maleic hydrazide is a plant growth inhibitor that has been used to slow the growth rate of grasses, including turfgrass, in order to reduce the need for cutting. However, the use of maleic hydrazide as a growth inhibitor in turfgrass systems can result in the encroachment of weeds as well as potentially phytotoxic effects on the turfgrass itself. The applicant has surprisingly discovered that maleic hydrazide may be used as an herbicide to control undesirable tuberous vegetation in turfgrass systems without adversely affecting the growth of the turfgrass. Additionally, when used according to the presently disclosed compositions and methods, the applicant has surprisingly discovered that maleic hydrazide may be used as a post-emergent herbicide for controlling nutsedge in turfgrass systems by killing nutsedge weeds and reducing nutsedge populations, as opposed to just temporarily suppressing nutsedge through growth inhibition. Additionally, the applicant has discovered that the presently disclosed compositions and methods may be operative to effectively control one or more nutsedge weeds in a turfgrass system or ornamental plant growing environment with just a single application rather than the sequential applications required by conventional herbicides. Accordingly, the presently disclosed compositions and methods may effectively control nutsedge weeds in turfgrass and ornamental plant growing environments when the maleic hydrazide herbicide is applied once per growing season or once per year.

When applied according to the presently disclosed methods, the applicant has discovered that the presently disclosed herbicidal compositions comprising maleic hydrazide may effectively reduce the nutsedge population in a plant growing environment by at least 80%. In at least some embodiments, the presently disclosed compositions and methods may be operable to achieve an 80% or greater reduction in nutsedge population following a single application of the herbicidal composition to the plant growth environment. In other embodiments, the presently disclosed compositions and methods may be operable to achieve an 80% or greater reduction in nutsedge population when application of the herbicidal composition to the plant growing environment is restricted to one application per year or one application per growing season. Further, this control efficacy against nutsedge weeds may be achieved in turfgrass systems or ornamental plant growing environments without the application of the herbicide significantly impacting the growth of the desirable turfgrass or ornamental plants. Additionally, the presently disclosed compositions and methods are effective for the control of nutsedge weeds in the absence of halosulfuron or the application of compositions or products containing halosulfuron. Furthermore, the applicant has surprisingly discovered that the presently disclosed compositions and methods may be used to effectively control nutsedge weeds at relatively low maleic hydrazide loadings, application rates, and application frequencies as a result of translocation of the maleic hydrazide from the foliage to the rhizomes of the nutsedge and from the rhizomes to the tubers of the nutsedge.

Embodiments of herbicidal compositions for the control of undesirable vegetation in a plant growing environment are provided. The herbicidal compositions may include an herbicidally effective amount of maleic hydrazide. In certain embodiments, the herbicidal compositions may include an herbicidally effective amount of one or more synthetic herbicides in addition to the herbicidally effective amount of maleic hydrazide. Accordingly, the presently disclosed herbicidal compositions may comprise an herbicidal mixture of maleic hydrazide and one or more synthetic herbicides.

The presently disclosed herbicidal compositions may be useful for the control of various types of undesirable vegetation, including one or more sedges or one or more plants belonging to the family Cyperaceae, Kyllinga or one or more plants belonging to the genus Kyllinga, and one or more nutsedge weeds or one or more plants belonging to the genus Cyperus, including, for example, yellow nutsedge or purple nutsedge. Additionally, the presently disclosed herbicidal compositions may be particularly useful for the control of the aforementioned types of undesirable vegetation in various plant growing environments, including lawns, golf courses, athletic fields, sod farms, parks, cemeteries, non-agricultural fields, plant nurseries, gravel pads, and roadways. The presently disclosed herbicidal compositions may also be particularly useful for the control of the aforementioned types of undesirable vegetation in plant growing environments in which the desirable plants being grown, cultivated, or maintained, in the plant growing environment are turfgrass or ornamental plants.

In particular embodiments, the presently disclosed herbicidal compositions are especially suited for the control of undesirable vegetation, such as one or more nutsedge weeds, in turfgrass systems or plant growing environments that include one or more turfgrasses or one or more stands of turfgrass. The turfgrass may be mowed or otherwise comprise mown turfgrass. The Applicant has discovered that the presently disclosed herbicidal compositions and methods may be more effective at controlling one or more nutsedge weeds in turfgrass systems when the turfgrass and/or the nutsedge weeds are mowed either prior to or following application of the herbicide. Accordingly, the one or more turfgrasses or one or more stands of turfgrass may be managed or manicured or be located in a managed or manicured plant growing environment. For example, the one or more turfgrasses or one or more stands of turfgrass may be located in a plant growing environment selected from the group consisting of lawns, golf courses, athletic fields, sod farms, parks, and cemeteries.

In certain embodiments, the one or more turfgrasses or one or more stands of turfgrass may comprises cool season turfgrasses. In other embodiments, the one or more turfgrasses or one or more stands of turfgrass may comprises warm season turfgrasses. In certain embodiments, examples of the one or more turfgrasses or one or more stands of turfgrass may include, but are not limited to, zoysia grasses, Bermuda grasses, hybrid bermudagrass, St. Augustine grass, centipede grass, carpet grass, Bahiagrass, Kikuyu grass, buffalo grass, seashore paspalum, creeping bentgrass, perennial ryegrass, Kentucky bluegrass, tall fescue, fine fescue, and combinations thereof.

The one or more turfgrasses or one or more stands of turfgrass may also include, but are not limited to, Cynodon dactylon, Zoysia Willd., Zoysia x forbesiana Traub, Zoysia x hondana Ohwi, Zoysia japonica, Zoysia macrantha, Zoysia macrostachya, Zoysia matrella, Zoysia minima, Zoysia pauciflora, Zoysia seslerioides, Zoysia sinica, Zoysia tenuifolia, Stenotaphrum secundatum, Eremochloa ophiuroides, grasses belonging to the genus Axonopus, Paspalum notatum, Cenchrus clandestinus, Buchloe dactyloides, and Paspalum vaginatum.

Additionally, the one or more turfgrasses or one or more stands or turfgrass may include annual or perennial Gramineae and grasses belonging to one or more of the genera Agropyron, Agrostis, Axonopus, Bromus, Buchloe, Cynodon, Eremochloa, Festuca, Lolium, Paspulum, Pennisetum, Phleum, Poa, Stenotaphrum or Zoysia, Sorghum, Andropogon, Bouteloua, Sorghastrum, Schizachyrium, Muhlenbergia, Koeleria and Panicum.

In particular embodiments, the presently disclosed herbicidal compositions are especially suited for the control of undesirable vegetation, such as one or more nutsedge weeds, in plant growing environments comprising ornamental plants. Examples of suitable ornamental plant growing environments may include plant nurseries and facility surrounds, potted ornamental plants, or containers containing one or more ornamental plants.

In certain embodiments, the presently disclosed herbicidal compositions may be formulated as a liquid formulation suitable to be applied or sprayed onto the plant growing environment. According to certain aspects of the present disclosure, the herbicidal composition may be suitable or otherwise formulated to be mixed with water and sprayed onto the plant growing environment. In other aspects, the herbicidal composition may be in the form of a or otherwise suitable to be formulated into a formulation selected from the group consisting of an emulsifiable concentrate (EC), emulsion-in-water (EW), suspension concentrated (SC), suspoemulsion (SE), flowable concentrate (FL), wettable powder (WP), soluble liquid concentrate (SL), soluble powder (SP), ultra low volume (ULV) spray, microencapsulated or capsule suspension (CS), water dispersible granule (WDG), and any combination thereof. In certain embodiments, the herbicidal composition may be operable to be formulated to form a ready to apply spray formulation. In one embodiment, the herbicidal composition may be in the form of or otherwise capable of being formulated into a spot spray to treat or control the undesirable vegetation in the plant growing environment. For example, the presently disclosed herbicide compositions may comprise a ready to apply spot spray for the control of one or more nutsedge weeds in turfgrass or in a plant growing environment in which one or more ornamental plants are present.

In certain embodiments, the presently disclosed herbicidal compositions, comprising an herbicidal mixture of maleic hydrazide and one or more synthetic herbicides, exhibits reduced phytotoxicity towards one or more desirable plants in the plant growing environment as compared to the phytotoxicity exhibited when the maleic hydrazide and the one or more synthetic herbicides are separately applied to the plant growing environment. For example, the herbicidal compositions, comprising an herbicidal mixture of maleic hydrazide and one or more synthetic herbicides, may exhibit reduced phytotoxicity towards one or more turfgrasses or one or more ornamental plants in the plant growing environment.

In certain embodiments, the presently disclosed herbicidal compositions, comprising an herbicidal mixture of maleic hydrazide and one or more synthetic herbicides, exhibits a synergistic herbicidal effect in mitigating or controlling the undesired vegetation in the plant growing environment as compared to separate application of maleic hydrazide and the one or more synthetic herbicides to the plant growing environment. For example, the herbicidal compositions, comprising an herbicidal mixture of maleic hydrazide and one or more synthetic herbicides, may exhibit a synergistic herbicidal effect towards one or more sedges, one or more plants belonging to the family Cyperaceae, one or more plants belonging to the genus Kyllinga, one or more plants belonging to the genus Cyperus, or one or more nutsedge weeds in the plant growing environment.

Embodiments of methods for controlling undesirable vegetation in a plant growing environment are provided. The methods may include contacting the undesirable vegetation in the plant growing environment with an herbicidally effective amount of any of the presently disclosed herbicidal compositions containing maleic hydrazide. The undesirable vegetation may be selected from the group consisting of one or more sedges or one or more plants belonging to the family Cyperaceae, Kyllinga or one or more plants belonging to the genus Kyllinga, and one or more nutsedge weeds or one or more plants belonging to the genus Cyperus. In certain embodiments, the undesirable vegetation may be one or more nutsedge weeds, for example yellow nutsedge or purple nutsedge, or one or more Kyllinga weeds. The undesirable vegetation may be contacted after the undesirable vegetation has emerged. Accordingly, the presently disclosed maleic hydrazide herbicidal compositions may be post-emergent herbicides and the presently disclosed methods include post-emergent application of the maleic hydrazide compositions to the plant growing environment.

The plant growing environment may comprise, among other embodiments, turfgrass or one or more ornamental plants. The presently disclosed methods may further include applying the herbicidal composition to the plant growing environment once per year or once per growing season. The methods may also include spraying an herbicidally effective amount of the herbicidal composition or an herbicidally effective amount of a liquid formulation comprising the herbicidal composition onto the undesirable vegetation or the plant growing environment comprising the undesirable vegetation.

According to another aspect of the present disclosure, a method for controlling one or more nutsedge weeds in turfgrass is provided. The method may include contacting the one or more nutsedge weeds in the turfgrass with an herbicidally effective amount of an herbicidal composition comprising maleic hydrazide. In certain embodiments, the herbicidal composition may comprise an herbicidal mixture of maleic hydrazide and one or more synthetic herbicides. The method may include the use of any of the presently disclosed herbicidal compositions comprising maleic hydrazide. Contacting the one or more nutsedge weeds with the herbicidally effective amount of the herbicidal composition may include applying a liquid formulation comprising the herbicidal composition to the one or more nutsedge weeds or the turfgrass comprising the one or more nutsedge weeds.

The method for controlling one or more nutsedge weeds in turfgrass may include contacting the one or more nutsedge weeds post-emergence such that the herbicidal composition comprising maleic hydrazide is used as a post-emergent herbicide on turfgrass following the emergence of one or more nutsedge weeds in the turfgrass. Contacting the one or more nutsedge weeds with the herbicidally effective amount of the herbicidal composition may be operable to effectively control the one or more nutsedge weeds in the turfgrass following a single contacting or application of the herbicidal composition. In at least certain embodiments, the post-emergent contact of the one or more nutsedge weeds in the turfgrass with the herbicidally effective amount of the herbicidal composition may result in an 80% or greater reduction in the population of the one or more nutsedge weeds in the turfgrass, following a single contacting or single application of the herbicidal composition with the one or more nutsedge weeds.

The turfgrass may include a turfgrass stand or one or more turfgrasses in a plant growing environment. The turfgrass may include any natural or commercial turfgrass, or any turfgrass that infested by one or more nutsedge weeds. In at least some embodiments, the turfgrass may include one or more cool season grasses. In certain embodiments, examples of the one or more turfgrasses or one or more stands of turfgrass may include, but are not limited to, zoysia grasses, Bermuda grasses, hybrid bermudagrass, St. Augustine grass, centipede grass, carpet grass, Bahiagrass, Kikuyu grass, buffalo grass, seashore paspalum, creeping bentgrass, perennial ryegrass, Kentucky bluegrass, tall fescue, fine fescue, and combinations thereof.

The turfgrass may be a managed or manicured turfgrass located in numerous plant growing environments, such as lawns, golf courses, athletic fields, sod farms, parks, non-agricultural fields, and cemeteries. The turfgrass may be located in any geographic location, including but not limited to, the United States, Japan, Australia, and New Zealand.

Contacting the one or more nutsedge weeds with the herbicidally effective amount of the herbicidal composition may include applying the herbicidal composition to the turfgrass from about April to about October or from about June to about August when the turfgrass is located in the Northern Hemisphere. The method for controlling one or more nutsedge weeds in turfgrass may include mowing the turfgrass or may include using a mower to cut, crop, or trim the turfgrass. The method may further include applying the herbicidal composition or a liquid formulation comprising the herbicidal composition to the turfgrass within one week of the turfgrass being mowed. The method may also include applying the herbicidal composition or a liquid formulation comprising the herbicidal composition directly to the one or more nutsedge weeds in the turfgrass as a spot spray application within ten days of the of the turfgrass being mowed.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other advantages and features of the present disclosure, will become apparent through reference to the following description and the accompanying drawings. Furthermore, it is to be understood that the features of the various embodiments described herein are not mutually exclusive and may exist in various combinations and permutations.

### DETAILED DESCRIPTION

The present disclosure describes various embodiments related to methods and compositions for controlling hard to control undesirable vegetation, such as nutsedge, in various plant growing environments, such as turfgrass systems and ornamental plant growing environments. Further embodiments may be described and disclosed.

In the following description, numerous details are set forth in order to provide a thorough understanding of the various embodiments. In other instances, well-known processes, devices, and systems may not have been described in particular detail in order not to unnecessarily obscure the various embodiments. Additionally, illustrations of the various embodiments may omit certain features or details in order to not obscure the various embodiments.

The description may use the phrases “in some embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “reducing,” “reduced,” or any variation thereof, when used in the claims and/or the specification includes any measurable decrease or complete inhibition to achieve a desired result.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

Disclosed herein are methods and compositions for controlling hard to control undesirable vegetation, such as nutsedge, in various plant growing environments, such as turfgrass systems and ornamental plant growing environments. When applied according to the presently disclosed methods, the applicant has discovered that the presently disclosed post-emergent herbicidal compositions comprising maleic hydrazide may effectively reduce the nutsedge population in a plant growing environment by at least 80%. In at least some embodiments, the presently disclosed compositions and methods may be operable to achieve an 80% or greater reduction in nutsedge population following a single application of the herbicidal composition to the plant growth environment. In other embodiments, the presently disclosed compositions and methods may be operable to achieve an 80% or greater reduction in nutsedge population when application of the herbicidal composition to the plant growing environment is restricted to one application per year or one application per growing season. Further, this control efficacy against nutsedge weeds may be achieved in turfgrass systems or ornamental plant growing environments without the application of the herbicide significantly impacting the growth of the desirable turfgrass or ornamental plants. Additionally, the presently disclosed compositions and methods are effective for the control of nutsedge weeds in the absence of halosulfuron or the application of compositions or products containing halosulfuron. Furthermore, the applicant has surprisingly discovered that the presently disclosed compositions and methods may be used to effectively control nutsedge weeds at relatively low maleic hydrazide loadings, application rates, and application frequencies as a result of translocation of the maleic hydrazide from the foliage to the rhizomes of the nutsedge and from the rhizomes to the tubers of the nutsedge.

According to at least one aspect of the present disclosure, an herbicidal composition for the control of undesirable vegetation in a plant growing environment is provided. The herbicidal composition may include an herbicidally effective amount of maleic hydrazide (C₄H₄N₂O₂), also referred to as 1,2-dihydropyridazine-3,6-dione. As used herein, the term “maleic hydrazide,” in all its forms, refers to technical maleic hydrazide as well as any herbicidally acceptable salt of maleic hydrazide, including maleic hydrazide potassium salt, such as 1,2-dihydro-3,6-pyridazinedione monopotassium salt.

The presently disclosed herbicidal compositions may include any herbicidally effective amount of maleic hydrazide, or herbicidally acceptable salt, solute, hydrate, or solvate thereof. In certain embodiments, the presently disclosed herbicidal compositions may include from about 0.1 weight % to about 85 weight % maleic hydrazide, or from about 0.1 weight % to about 5 weight % maleic hydrazide, or from about 10 weight % to about 22 weight % maleic hydrazide, or from about 8 weight % to about 25 weight % maleic hydrazide, or from about 10 weight % to about 12 weight % maleic hydrazide, or from about 20 weight % to about 23 weight % maleic hydrazide, or from about 5 weight % to about 30 weight % maleic hydrazide.

According to certain embodiments, the herbicidal compositions may include less than 0.50% by weight maleic hydrazide. In certain embodiments, the maleic hydrazide comprises from about 0.05% to about 0.45% by weight of the herbicidal composition, or from about 0.25% to about 0.45% by weight of the herbicidal composition, or from about 0.05% to about 0.25% by weight of the herbicidal composition, or from about 0.1% to about 0.4% by weight of the herbicidal composition, or from about 0.15% to about 0.35% by weight of the herbicidal composition.

In certain embodiments, the herbicidal compositions may include an herbicidally effective amount of one or more synthetic herbicides in addition to the herbicidally effective amount of maleic hydrazide. Accordingly, the presently disclosed herbicidal compositions may comprise an herbicidal mixture of maleic hydrazide and one or more synthetic herbicides. In certain embodiments, the one or more synthetic herbicides may include one or more sulfonylurea herbicides. Non-limiting examples of synthetic herbicides that may be included in the presently disclosed herbicidal compositions may include carfentrazone, sulfosulfuron, imazosulfuron, 2,4-D, dicamba, halosulfuron, sulfentrazone, florpyrauxifen-benzyl, halauxifen-methyl, and any combination thereof. In at least certain embodiments, the herbicidal compositions or herbicidal mixtures excludes halosulfuron or otherwise does not include halosulfuron.

In certain embodiments, the presently disclosed herbicidal compositions, comprising an herbicidal mixture of maleic hydrazide and one or more synthetic herbicides, exhibits reduced phytotoxicity towards one or more desirable plants in the plant growing environment as compared to the phytotoxicity exhibited when the maleic hydrazide and the one or more synthetic herbicides are separately applied to the plant growing environment. For example, the herbicidal compositions, comprising an herbicidal mixture of maleic hydrazide and one or more synthetic herbicides, may exhibit reduced phytotoxicity towards one or more turfgrasses or one or more ornamental plants in the plant growing environment.

In certain embodiments, the presently disclosed herbicidal compositions, comprising an herbicidal mixture of maleic hydrazide and one or more synthetic herbicides, exhibits a synergistic herbicidal effect in mitigating or controlling the undesired vegetation in the plant growing environment as compared to separate application of maleic hydrazide and the one or more synthetic herbicides to the plant growing environment. For example, the herbicidal compositions, comprising an herbicidal mixture of maleic hydrazide and one or more synthetic herbicides, may exhibit a synergistic herbicidal effect towards one or more sedges, one or more plants belonging to the family Cyperaceae, one or more plants belonging to the genus Kyllinga, one or more plants belonging to the genus Cyperus, or one or more nutsedge weeds in the plant growing environment.

According to an aspect of the present disclosure, when the presently disclosed herbicidal compositions comprise an herbicidal mixture of maleic hydrazide and one or more synthetic herbicides, the ratio by weight of maleic hydrazide to the one or more synthetic herbicides may be from about 4:1 to about 16:1, or from about 4:1 to about 10:1, or from about 2:1 to about 32:1, or from about 4:1 to about 32:1, or from about 8:1 to about 32:1, or from about 8:1 to about 16:1, or from about 16:1 to about 32:1.

The presently disclosed herbicidal composition may generally be in liquid form or otherwise be in the form of a liquid formulation suitable to be applied as a liquid or sprayed onto the plant growing environment. In certain embodiments, the herbicidal compositions may be formulated or otherwise suited to be mixed with water and sprayed onto the plant growing environment. In certain embodiments, the herbicidal composition may be operable to be formulated to form a ready to apply spray formulation. In certain aspects, the herbicidal composition may be in the form of or otherwise capable of being formulated into a spot spray to treat or control the undesirable vegetation in the plant growing environment.

The herbicidal composition may be formulated into any formulation necessary to carry out the presently disclosed methods. For example, the herbicidal composition may be in the form of a formulation selected from the group consisting of an emulsifiable concentrate (EC), emulsion-in-water (EW), suspension concentrated (SC), suspoemulsion (SE), flowable concentrate (FL), wettable powder (WP), soluble liquid concentrate (SL), soluble powder (SP), ultra low volume (ULV) spray, microencapsulated or capsule suspension (CS), water dispersible granule (WDG), and any combination thereof.

The herbicidal compositions may include any adjuvant or additional chemical component necessary to achieve the presently disclosed compositions or formulations. In certain embodiments, the herbicidal compositions may include a non-ionic surfactant. In some instances, all of the surfactants included in the presently disclosed herbicidal compositions may be exclusively non-ionic surfactants. In certain embodiments, the herbicidal compositions may not include or otherwise may exclude an ionic surfactant, such as an ammoniated soap of fatty acid. In certain embodiments, the presently disclosed herbicidal compositions do not include an ammoniated soap of fatty acid. In some instances, the presently disclosed herbicidal compositions may exclude an ammoniated soap of fatty acid. In certain embodiments, the herbicidal compositions may include a turfgrass safener.

According to an aspect of the present disclosure, methods for controlling undesirable vegetation in a plant growing environment are provided. The methods may include contacting the undesirable vegetation in the plant growing environment with an herbicidally effective amount of any of the presently disclosed herbicidal compositions containing maleic hydrazide. The undesirable vegetation may be selected from the group consisting of one or more sedges or one or more plants belonging to the family Cyperaceae, Kyllinga or one or more plants belonging to the genus Kyllinga, and one or more nutsedge weeds or one or more plants belonging to the genus Cyperus. In certain embodiments, the undesirable vegetation may be one or more nutsedge weeds, for example yellow nutsedge or purple nutsedge, or one or more Kyllinga weeds. The undesirable vegetation may be contacted after the undesirable vegetation has emerged. Accordingly, the presently disclosed maleic hydrazide herbicidal compositions may be post-emergent herbicides and the presently disclosed methods include post-emergent application of the maleic hydrazide compositions to the plant growing environment.

The plant growing environment may be any environment in which plants, particularly turfgrasses and ornamental plants, are grown. Examples of plant growing environments may include lawns, golf courses, athletic fields, sod farms, parks, cemeteries, non-agricultural fields, plant nurseries, gravel pads, and roadways. The plant growing environment may comprise, among other embodiments, turfgrass or one or more ornamental plants. The plant growing environment may be located in any geographic location, including, for example, the United States, Japan, Australia, and New Zealand.

The presently disclosed methods may further include applying the herbicidal composition to the plant growing environment once per year or once per growing season. The methods may also include spraying an herbicidally effective amount of the herbicidal composition or an herbicidally effective amount of a liquid formulation comprising the herbicidal composition onto the undesirable vegetation or the plant growing environment comprising the undesirable vegetation. The methods may also include restricting the application of the herbicidal composition to the plant growing environment to one application per growing season or restricting the application of the herbicidal composition to the plant growing environment to one application per year.

In at least some embodiments of the method, halosulfuron or a herbicide comprising halosulfuron is not applied to the plant growing environment. In certain embodiments, an 80% or greater reduction in the population of the undesirable vegetation in the plant growing environment may be achieved in the absence of applying halosulfuron or an herbicide comprising halosulfuron to the plant growing environment.

In certain embodiments, contacting the undesirable vegetation may include applying the herbicidal composition to the undesirable vegetation or plant growing environment comprising the undesirable vegetation in an amount of from about 100 grams to about 4200 grams maleic hydrazide per hectare (ha), or in an amount of from about 100 grams to about 7000 grams maleic hydrazide per hectare (ha), or in an amount of from about 100 grams to about 3500 grams maleic hydrazide per hectare (ha), or in an amount of from about 100 grams to about 1000 grams maleic hydrazide per hectare (ha), or in an amount of from about 150 grams to about 1000 grams maleic hydrazide per hectare (ha), or in an amount of from about 150 grams to about 3500 grams maleic hydrazide per hectare (ha), or in an amount of from about 150 grams to about 500 grams maleic hydrazide per hectare (ha) of undesirable vegetation or plant growing environment comprising the undesirable vegetation. In certain embodiments, contacting the undesirable vegetation with the herbicidally effective amount of the herbicidal composition may include applying a liquid formulation comprising the herbicidal composition to the undesirable vegetation or the plant growing environment comprising the undesirable vegetation. The method may further include spraying an herbicidally effective amount of the herbicidal composition or an herbicidally effective amount of a liquid formulation comprising the herbicidal composition according onto the undesirable vegetation or the plant growing environment comprising the undesirable vegetation. In some instances, contacting the undesirable vegetation with the herbicidally effective amount of the herbicidal composition comprises applying the herbicidal composition to the undesirable vegetation or the plant growing environment comprising the undesirable vegetation from about April to October or from about June to August when the turfgrass is located in the Northern Hemisphere.

In certain embodiments, the plant growing environment may include one or more ornamental plants. The one or more ornamental plants may be planted in the ground, for example, in residential or commercial landscaping, adjacent to residential or commercial lawns, parks, golf courses, cemeteries, non-agricultural fields, and roadways. The one or more ornamental plants may also be planted in a container. For example, the one or more ornamental plants may be planted in containers, planters, pots, or the like in a container-based or field commercial growing environment, such as a plant nursery, or in commercial or residential landscaping or other similar plant growing environment. Non-limiting examples of ornamental plants that may be treated according to the presently disclosed methods may include, for example, Aglaonema, Aphelandra, Azalea, Bougainvillea, Boxwood, Cattelya skinneri, Cissus, Dieffenbachia, Hibiscus, Juniper, Leather-lead Fern, Pittosporum, Philodendron, Pothos, Rhododendron, Spathiphyllum, Taxus media, Japanese Holly, Monterey Pine, Pieris, Schefflera, Begonia, Pansy, Vinca, Marigold, Zinnia, Petunia, Geranium, Impatiens, Douglas Firs, Spruce, Pines, Ornamental Pear, Pyracantha, Hawthorn, English Ivy, Anthurium, Syngonium, and Ficus.

According to another aspect of the present disclosure, a method for controlling one or more nutsedge weeds in turfgrass is provided. The method may include contacting the one or more nutsedge weeds in the turfgrass with an herbicidally effective amount of an herbicidal composition comprising maleic hydrazide. In certain embodiments, the herbicidal composition may comprise an herbicidal mixture of maleic hydrazide and one or more synthetic herbicides. The method may include the use of any of the presently disclosed herbicidal compositions comprising maleic hydrazide. Contacting the one or more nutsedge weeds with the herbicidally effective amount of the herbicidal composition may include applying a liquid formulation comprising the herbicidal composition to the one or more nutsedge weeds or the turfgrass comprising the one or more nutsedge weeds.

The method for controlling one or more nutsedge weeds in turfgrass may include contacting the one or more nutsedge weeds post-emergence such that the herbicidal composition comprising maleic hydrazide is used as a post-emergent herbicide on turfgrass following the emergence of one or more nutsedge weeds in the turfgrass. Contacting the one or more nutsedge weeds with the herbicidally effective amount of the herbicidal composition may include causing the foliage, rhizome, or tuber of the one or more nutsedge weeds to be contacted by the herbicidal composition. Furthermore, contacting the one or more nutsedge weeds with the herbicidally effective amount of the herbicidal composition may include applying a liquid formulation comprising the herbicidal composition to the one or more nutsedge weeds or the turfgrass comprising the one or more nutsedge weeds. The method for controlling one or more nutsedge weeds in turfgrass may also include spraying an herbicidally effective amount of the herbicidal composition or an herbicidally effective amount of a liquid formulation comprising the herbicidal composition onto the one or more nutsedge weeds or the turfgrass comprising the one or more nutsedge weeds.

Contacting the one or more nutsedge weeds with the herbicidally effective amount of the herbicidal composition may be operable to effectively control the one or more nutsedge weeds in the turfgrass following a single contacting or application of the herbicidal composition. In at least certain embodiments, the post-emergent contact of the one or more nutsedge weeds in the turfgrass with the herbicidally effective amount of the herbicidal composition may result in an 80% or greater reduction in the population of the one or more nutsedge weeds in the turfgrass, following a single contacting or single application of the herbicidal composition with the one or more nutsedge weeds.

The method for controlling one or more nutsedge weeds in turfgrass may also include causing the application of an herbicidally effective amount of the herbicidal composition to the turfgrass comprising one or more nutsedge weeds such that the one or more nutsedge weeds in the turfgrass is contacted by an herbicidally effective amount of the herbicidal composition. The method may also include applying the herbicidal composition to the turfgrass once per year or once per growing season. In certain embodiments, application of an herbicidally effective amount of the herbicidal composition to the turfgrass may be operable to effectively control the one or more nutsedge weeds in the turfgrass following a single application. The application of the herbicidal composition to the turfgrass may also result in an 80% or greater reduction in the population of the one or more nutsedge weeds in the turfgrass, following a single application of the herbicidal composition to the turfgrass. Further, application of the herbicidal composition to the turfgrass may be operable to cause an 80% or greater reduction in nutsedge population in the turfgrass when the herbicidal composition is applied to the turfgrass once per year or once per growing season. In certain cases, the 80% or greater reduction in the population of the one or more nutsedge weeds in the turfgrass may be achieved in the absence of applying halosulfuron to the turfgrass.

In certain embodiments of the method for controlling one or more nutsedge weeds in turfgrass, the application of the herbicidal composition to the turfgrass may be restricted to one application per year or one application per growing season. Contacting the one or more nutsedge weeds may include applying the herbicidal composition to the one or more nutsedge weeds or turfgrass comprising the one or more nutsedge weeds in an amount of from about 100 grams to about 4200 grams maleic hydrazide per hectare (ha) of turfgrass, or in an amount of from about 100 grams to about 7000 grams maleic hydrazide per hectare (ha) of turfgrass, or in an amount of from about 100 grams to about 3500 grams maleic hydrazide per hectare (ha) of turfgrass, or in an amount of from about 100 grams to about 1000 grams maleic hydrazide per hectare (ha) of turfgrass, or in an amount of from about 150 grams to about 1000 grams maleic hydrazide per hectare (ha) of turfgrass, or in an amount of from about 150 grams to about 3500 grams maleic hydrazide per hectare (ha) of turfgrass, in an amount of from about 150 grams to about 500 grams maleic hydrazide per hectare (ha) of turfgrass.

The turfgrass may include a turfgrass stand or one or more turfgrasses in a plant growing environment. The turfgrass may include any natural or commercial turfgrass, or any turfgrass that infested by one or more nutsedge weeds. In at least some embodiments, the turfgrass may include one or more cool season grasses. Examples of the one or more turfgrasses or one or more stands of turfgrass may include, but are not limited to, zoysia grasses, Bermuda grasses, hybrid bermudagrass, St. Augustine grass, centipede grass, carpet grass, Bahiagrass, Kikuyu grass, buffalo grass, seashore paspalum, perennial ryegrass, Kentucky bluegrass, tall fescue, fine fescue, and combinations thereof.

The turfgrass may be a managed or manicured turfgrass located in numerous plant growing environments, such as lawns, golf courses, athletic fields, sod farms, parks, non-agricultural fields, and cemeteries. The turfgrass may be located in any geographic location, including but not limited to, the United States, Japan, Australia, and New Zealand.

Contacting the one or more nutsedge weeds with the herbicidally effective amount of the herbicidal composition may include applying the herbicidal composition to the turfgrass from about April to about October or from about June to about August when the turfgrass is located in the Northern Hemisphere. The method for controlling one or more nutsedge weeds in turfgrass may include mowing the turfgrass or may include using a mower to cut, crop, or trim the turfgrass. The method may further include applying the herbicidal composition or a liquid formulation comprising the herbicidal composition to the turfgrass within one week of the turfgrass being mowed. The method may also include applying the herbicidal composition or a liquid formulation comprising the herbicidal composition directly to the one or more nutsedge weeds in the turfgrass as a spot spray application within ten days of the of the turfgrass being mowed.

### Statements of the Disclosure

Statement 1: An herbicidal composition for the control of undesirable vegetation in a plant growing environment, the composition comprising: an herbicidally effective amount of maleic hydrazide.

Statement 2: The herbicidal composition according to Statement 1, further comprising: an herbicidally effective amount of one or more synthetic herbicides.

Statement 3: The herbicidal compositions according to Statement 2, wherein the one or more synthetic herbicides is selected from the group consisting of 2,4-D, dicamba, halosulfuron, sulfentrazone, and any combination thereof.

Statement 4: The herbicidal compositions according to Statement 2, wherein the one or more synthetic herbicides is selected from the group consisting of carfentrazone, sulfosulfuron, imazosulfuron, 2,4-D, dicamba, halosulfuron, sulfentrazone, florpyrauxifen-benzyl, halauxifen-methyl, and any combination thereof.

Statement 5: The herbicidal composition according to any one of Statements 1-4, further comprising a non-ionic surfactant.

Statement 6: The herbicidal composition according to any one of Statements 1-5, further comprising an adjuvant.

Statement 7: The herbicidal composition according to any one of Statements 1-6, wherein the composition does not include an ionic surfactant.

Statement 8: The herbicidal composition according to any one of Statements 1-6, wherein the composition excludes an ionic surfactant.

Statement 9: The herbicidal composition according to Statement 7 or Statement 8, wherein the ionic surfactant is an ammoniated soap of fatty acid.

Statement 10: The herbicidal composition according to any one of Statements 1-6, wherein the composition does not include an ammoniated soap of fatty acid.

Statement 11: The herbicidal composition according to any one of Statements 1-6, wherein the composition excludes an ammoniated soap of fatty acid.

Statement 12: The herbicidal composition according to any one of Statements 1-11, wherein maleic hydrazide comprises from about 5% to about 30% by weight of the herbicidal composition.

Statement 13: The herbicidal composition according to any one of Statements 1-11, wherein maleic hydrazide comprises from about 0.1% to about 85% by weight of the herbicidal composition.

Statement 14: The herbicidal composition according to any one of Statements 1-11, wherein maleic hydrazide comprises from about 8% to about 25% by weight of the herbicidal composition.

Statement 15: The herbicidal composition according to any one of Statements 1-11, wherein maleic hydrazide comprises from about 10% to about 22% by weight of the herbicidal composition.

Statement 16: The herbicidal composition according to any one of Statements 1-11, wherein maleic hydrazide comprises from about 10% to about 12% by weight of the herbicidal composition.

Statement 17: The herbicidal composition according to any one of Statements 1-11, wherein maleic hydrazide comprises from about 20% to about 23% by weight of the herbicidal composition.

Statement 18: The herbicidal composition according to any one of Statements 1-17, wherein the herbicidal composition is a liquid formulation suitable to be applied or sprayed onto the plant growing environment.

Statement 19: The herbicidal composition according to any one of Statements 1-17, wherein the maleic hydrazide comprises maleic hydrazide potassium salt.

Statement 20: The herbicidal composition according to any one of Statements 1-17, wherein the maleic hydrazide comprises 1,2-dihydro-3,6-pyridazinedione monopotassium salt.

Statement 21: The herbicidal composition according to any one of Statements 1-17, wherein the herbicidal composition is a suitable to be mixed with water and sprayed onto the plant growing environment.

Statement 22: The herbicidal composition according to any one of Statements 1-17, wherein the herbicidal composition is operable to be formulated to form a ready to apply spray formulation.

Statement 23: The herbicidal composition according to any one of Statements 1-17, wherein the herbicidal composition is in the form of a formulation selected from the group consisting of an emulsifiable concentrate (EC), emulsion-in-water (EW), suspension concentrated (SC), suspoemulsion (SE), flowable concentrate (FL), wettable powder (WP), soluble liquid concentrate (SL), soluble powder (SP), ultra low volume (ULV) spray, microencapsulated or capsule suspension (CS), water dispersible granule (WDG), and any combination thereof.

Statement 24: The herbicidal composition according to any one of Statements 1-17, wherein the herbicidal composition is in the form of or otherwise capable of being formulated into a spot spray to treat or control the undesirable vegetation in the plant growing environment.

Statement 25: The herbicidal composition according to any one of Statements 2-23, wherein the plant growing environment comprises one or more turfgrasses or one or more ornamental plants, wherein the phytotoxic effects of application of the herbicidal composition to the one or more turfgrasses or one or more ornamental plants is less than the phytotoxic effects exhibited when the same amount of maleic hydrazide and the one or more synthetic herbicides are separately applied to the one or more turfgrasses or one or more ornamental plants.

Statement 26: The herbicidal composition according to any one of Statements 2-23, wherein the herbicidal composition exhibits a synergistic effect in mitigating or controlling the undesired vegetation in the plant growing environment as compared to separate application of maleic hydrazide and the one or more synthetic herbicides to the plant growing environment.

Statement 27: The herbicidal composition according to any one of Statements 1-26, wherein the undesirable vegetation comprises one or more sedges or one or more plants belonging to the family Cyperaceae.

Statement 28: The herbicidal composition according to any one of Statements 1-27, wherein the undesirable vegetation comprises Kyllinga or one or more plants belonging to the genus Kyllinga.

Statement 29: The herbicidal composition according to any one of Statements 1-27, wherein the undesirable vegetation comprises one or more nutsedge weeds or one or more plants belonging to the genus Cyperus.

Statement 30: The herbicidal composition according to Statement 29, wherein the undesirable vegetation comprises yellow nutsedge or purple nutsedge.

Statement 31: The herbicidal composition according to any one of Statements 27-30, wherein the undesirable vegetation is mowed or mown.

Statement 32: The herbicidal composition according to any one of Statements 27-30, wherein the plant growing environment is mowed or mown.

Statement 33: The herbicidal composition according to any one of Statements 1-32, wherein the plant growing environment is selected from the group consisting of lawns, golf courses, athletic fields, sod farms, parks, cemeteries, non-agricultural fields, plant nurseries, gravel pads, and roadways.

Statement 34: The herbicidal composition according to any one of Statements 1-32, wherein the plant growing environment is a plant nursery comprising container or field grown plants.

Statement 35: The herbicidal composition according to Statement 34, wherein the potted plants comprise ornamental plants.

Statement 36: The herbicidal composition according to any one of Statements 1-32, wherein the plant growing environment comprises one or more turfgrasses or one or more stands of turfgrass.

Statement 37: The herbicidal composition according to Statement 36, wherein the one or more turfgrasses or one or more stands of turfgrass is mowed or mown.

Statement 38: The herbicidal composition according to Statement 36, wherein the one or more turfgrasses or one or more stands of turfgrass is managed or manicured.

Statement 39: The herbicidal composition according to Statement 36, wherein the one or more turfgrasses or one or more stands is maintained or cultivated using a mower operable to cut, crop, or trim the one or more turfgrasses or one or more stands of turfgrass in the plant growing environment.

Statement 40: The herbicidal composition according to any one of Statements 36-39, wherein the one or more turfgrasses or one or more stands of turfgrass is located in a plant growing environment selected from the group consisting of lawns, golf courses, athletic fields, sod farms, parks, and cemeteries.

Statement 41: The herbicidal composition according to any one of Statements 36-40, further comprising a turfgrass safener.

Statement 42: The herbicidal composition according to any one of Statements 36-41, wherein the one or more turfgrasses or one or more stands of turfgrass comprises one or more selected from the group consisting of creeping bentgrass, perennial ryegrass, Kentucky bluegrass, tall fescue, fine fescue, and any combination thereof.

Statement 43: The herbicidal composition according to any one of Statements 36-41, wherein the one or more turfgrasses or one or more stands of turfgrass comprises one or more selected from the group consisting of zoysia grasses, Bermuda grasses, hybrid bermudagrass, St. Augustine grass, centipede grass, carpet grass, Bahiagrass, Kikuyu grass, buffalo grass, seashore paspalum, and any combinations thereof.

Statement 44: The herbicidal composition according to any one of Statements 36-41, wherein the one or more turfgrasses or one or more stands of turfgrass comprises one or more selected from the group consisting of zoysia grasses, Bermuda grasses, hybrid bermudagrass, St. Augustine grass, centipede grass, carpet grass, Bahiagrass, Kikuyu grass, buffalo grass, seashore paspalum, creeping bentgrass, perennial ryegrass, Kentucky bluegrass, tall fescue, fine fescue, and any combinations thereof.

Statement 45: The herbicidal composition according to any one of Statements 1-44, wherein the plant growing environment is located in a geographic location selected from the group consisting of the United States, Japan, Australia, and New Zealand.

Statement 46: The composition according to any one of Statements 2-45, wherein the herbicidal composition comprises an herbicidal mixture of maleic hydrazide and one or more synthetic herbicides.

Statement 47: The composition according to Statement 46, wherein the ratio by weight of maleic hydrazide to the one or more synthetic herbicides is from about 4:1 to about 16:1.

Statement 48: The composition according to Statement 46, wherein the ratio by weight of maleic hydrazide to the one or more synthetic herbicides is from about 2:1 to about 32:1.

Statement 49: The composition according to Statement 46, wherein the ratio by weight of maleic hydrazide to the one or more synthetic herbicides is from about 4:1 to about 10:1.

Statement 50: The composition according to Statement 46, wherein the ratio by weight of maleic hydrazide to the one or more synthetic herbicides is from about 8:1 to about 32:1.

Statement 51: The composition according to Statement 46, wherein the ratio by weight of maleic hydrazide to the one or more synthetic herbicides is from about 8:1 to about 16:1.

Statement 52: The composition according to Statement 46, wherein the ratio by weight of maleic hydrazide to the one or more synthetic herbicides is from about 16:1 to about 32:1.

Statement 53: A method for controlling undesirable vegetation in a plant growing environment, the method comprising contacting the undesirable vegetation in the plant growing environment with an herbicidally effective amount of an herbicidal composition according to any one of Statements 1-52.

Statement 54: The method according to Statement 53, wherein the undesirable vegetation is selected from the group consisting of one or more sedges or one or more plants belonging to the family Cyperaceae, Kyllinga or one or more plants belonging to the genus Kyllinga, and one or more nutsedge weeds or one or more plants belonging to the genus Cyperus.

Statement 55: The method according to Statement 54, wherein the undesirable vegetation is one or more nutsedge weeds.

Statement 56: The method according to Statement 55, wherein the one or more nutsedge weeds is selected from the group consisting of yellow nutsedge, purple nutsedge, and combinations thereof.

Statement 57: The method according to any one of Statements 53-56, wherein the undesirable vegetation is contacted post-emergence.

Statement 58: The method according to any one of Statements 53-57, wherein the plant growing environment is selected from the group consisting of lawns, golf courses, athletic fields, sod farms, parks, cemeteries, non-agricultural fields, plant nurseries, gravel pads, and roadways.

Statement 59: The method according to any one of Statements 53-58, wherein the plant growing environment comprises one or more turfgrasses or one or more ornamental plants.

Statement 60: The method according to Statement 59, wherein the undesirable vegetation is selected from the group consisting of one or more sedges or one or more plants belonging to the family Cyperaceae, Kyllinga or one or more plants belonging to the genus Kyllinga, and one or more nutsedge weeds or one or more plants belonging to the genus Cyperus; and wherein post-emergent contact of the undesirable vegetation in the plant growing environment, comprising one or more turfgrasses or one or more ornamental plants, with the herbicidally effective amount of the herbicidal composition results in an 80% or greater reduction in the population of the undesirable vegetation in the plant growing environment, following a single application of the herbicidal composition to the plant growing environment.

Statement 61: The method according to Statement 60, wherein the application of the herbicidal composition to the plant growing environment is restricted to one application per year.

Statement 62: The method according to Statement 60, wherein the application of the herbicidal composition to the plant growing environment is restricted to one application per growing season.

Statement 63: The method according to any one of Statements 60-62, wherein the 80% or greater reduction in the population of the undesirable vegetation in the plant growing environment is achieved without the application of halosulfuron to the plant growing environment.

Statement 64: The method according to any one of Statements 60-62, wherein halosulfuron is not applied to the plant growing environment.

Statement 65: The method according to any one of Statements 53-64, further comprising: applying the herbicidal composition to the plant growing environment once per year.

Statement 66: The method according to any one of Statements 53-64, further comprising: applying the herbicidal composition to the plant growing environment once per growing season.

Statement 67: The method according to any one of Statements 53-64, further comprising: restricting the application of the herbicidal composition to the plant growing environment to one application per growing season.

Statement 68: The method according to any one of Statements 53-67, wherein the plant growing environment comprises one or more ornamental plants.

Statement 69: The method according to Statement 68, wherein the one or more ornamental plants is in a container.

Statement 70: The method according to Statement 69, wherein the container is located in a plant nursery or container-based commercial growing environment.

Statement 71: The method according to any one of Statements 53-70, wherein contacting the undesirable vegetation comprises applying the herbicidal composition to the undesirable vegetation or plant growing environment comprising the undesirable vegetation in an amount of from about 100 grams to about 4200 grams maleic hydrazide per hectare (ha) of undesirable vegetation or plant growing environment comprising the undesirable vegetation.

Statement 72: The method according to any one of Statements 53-70, wherein contacting the undesirable vegetation comprises applying the herbicidal composition to the undesirable vegetation or plant growing environment comprising the undesirable vegetation in an amount of from about 100 grams to about 7000 grams maleic hydrazide per hectare (ha) of undesirable vegetation or plant growing environment comprising the undesirable vegetation.

Statement 73: The method according to any one of Statements 53-70, wherein contacting the undesirable vegetation comprises applying the herbicidal composition to the undesirable vegetation or plant growing environment comprising the undesirable vegetation in an amount of from about 100 grams to about 3500 grams maleic hydrazide per hectare (ha) of undesirable vegetation or plant growing environment comprising the undesirable vegetation.

Statement 74: The method according to any one of Statements 53-70, wherein contacting the undesirable vegetation comprises applying the herbicidal composition to the undesirable vegetation or plant growing environment comprising the undesirable vegetation in an amount of from about 100 grams to about 1000 grams maleic hydrazide per hectare (ha) of undesirable vegetation or plant growing environment comprising the undesirable vegetation.

Statement 75: The method according to any one of Statements 53-70, wherein contacting the undesirable vegetation comprises applying the herbicidal composition to the undesirable vegetation or plant growing environment comprising the undesirable vegetation in an amount of from about 150 grams to about 1000 grams maleic hydrazide per hectare (ha) of undesirable vegetation or plant growing environment comprising the undesirable vegetation.

Statement 76: The method according to any one of Statements 53-70, wherein contacting the undesirable vegetation comprises applying the herbicidal composition to the undesirable vegetation or plant growing environment comprising the undesirable vegetation in an amount of from about 150 grams to about 3500 grams maleic hydrazide per hectare (ha) of undesirable vegetation or plant growing environment comprising the undesirable vegetation.

Statement 77: The method according to any one of Statements 53-70, wherein contacting the undesirable vegetation comprises applying the herbicidal composition to the undesirable vegetation or plant growing environment comprising the undesirable vegetation in an amount of from about 150 grams to about 500 grams maleic hydrazide per hectare (ha) of undesirable vegetation or plant growing environment comprising the undesirable vegetation.

Statement 78: The method according to any one of Statements 53-77, wherein contacting the undesirable vegetation with the herbicidally effective amount of the herbicidal composition comprises applying the herbicidal composition to the undesirable vegetation or the plant growing environment comprising the undesirable vegetation from about April to October or from about June to August when the plant growing environment is located in the Northern Hemisphere.

Statement 79: The method according to any one of Statements 53-78, wherein contacting the undesirable vegetation with the herbicidally effective amount of the herbicidal composition comprises applying a liquid formulation comprising the herbicidal composition to the undesirable vegetation or the plant growing environment comprising the undesirable vegetation.

Statement 80: The method according to any one of Statements 53-78, further comprising: spraying an herbicidally effective amount of the herbicidal composition or an herbicidally effective amount of a liquid formulation comprising the herbicidal composition according to any one of Statements 1-52 onto the undesirable vegetation or the plant growing environment comprising the undesirable vegetation.

Statement 81: The method according to any one of Statements 53-80, wherein the plant growing environment is located in a geographic location selected from the group consisting of the United States, Japan, Australia, and New Zealand.

Statement 82: The method according to any one of Statements 53-81, wherein the plant growing environment is a turfgrass system, the turfgrass system comprising one or more turfgrasses or one or more stands of turfgrass.

Statement 83: The method according to Statement 82, further comprising: mowing the one or more turfgrasses or one or more stands of turfgrass in the turfgrass system or plant growing environment.

Statement 84: The method according to Statement 82 or Statement 83, further comprising: using a mower to cut, crop, or trim the one or more turfgrasses or one or more stands of turfgrass in the plant growing environment.

Statement 85: The method according to Statement 83 or Statement 84, further comprising: applying the herbicidal composition or a liquid formulation comprising the herbicidal composition to the turfgrass system within one week of the turfgrass system being mowed.

Statement 86: The method according to Statement 83 or Statement 84, further comprising: applying the herbicidal composition or a liquid formulation comprising the herbicidal composition directly to the undesirable vegetation in the turfgrass system as a spot spray application within ten days of the of the turfgrass system being mowed.

Statement 87: The method according to Statement 86, wherein the undesirable vegetation is one or more nutsedge weeds or one or more Kyllinga weeds.

Statement 88: The method according to any one of Statements 82-87, wherein the turfgrass system is a managed or manicured turfgrass system located in selected from the group consisting of lawns, golf courses, athletic fields, sod farms, parks, and cemeteries.

Statement 89: The method according to any one of Statements 82-88, wherein the one or more one or more turfgrasses or one or more stands of turfgrass is located in a plant growing environment selected from the group consisting of lawns, golf courses, athletic fields, sod farms, parks, and cemeteries.

Statement 90: The method according to any one of Statements 82-89, wherein the one or more turfgrasses or one or more stands of turfgrass comprises one or more selected from the group consisting of creeping bentgrass, perennial ryegrass, Kentucky bluegrass, tall fescue, fine fescue, and any combination thereof.

Statement 91: The method according to any one of Statements 82-89, wherein the one or more turfgrasses or one or more stands of turfgrass comprises one or more selected from the group consisting of zoysia grasses, Bermuda grasses, hybrid bermudagrass, St. Augustine grass, centipede grass, carpet grass, Bahiagrass, Kikuyu grass, buffalo grass, seashore paspalum, and any combinations thereof.

Statement 92: The method according to any one of Statements 82-89, wherein the one or more turfgrasses or one or more stands of turfgrass comprises one or more selected from the group consisting of zoysia grasses, Bermuda grasses, hybrid bermudagrass, St. Augustine grass, centipede grass, carpet grass, Bahiagrass, Kikuyu grass, buffalo grass, seashore paspalum, creeping bentgrass, perennial ryegrass, Kentucky bluegrass, tall fescue, fine fescue, and any combinations thereof.

Statement 93: The method according to any one of Statements 82-89, wherein the one or more turfgrasses or one or more stands of turfgrass comprises a cool season grass.

Statement 94: A method for controlling one or more nutsedge weeds in turfgrass, the method comprising contacting the one or more nutsedge weeds in the turfgrass with an herbicidally effective amount of an herbicidal composition comprising maleic hydrazide.

Statement 95: The method according to Statement 94, wherein the herbicidal composition comprises an herbicidal composition according to any one of Statements 1-52.

Statement 96: The method according to Statement 94 or Statement 95, wherein the one or more nutsedge weeds is selected from the group consisting of yellow nutsedge, purple nutsedge, and combinations thereof.

Statement 97: The method according to any one of Statements 94-96, wherein the one or more nutsedge weeds is contacted post-emergence.

Statement 98: The method according to any one of Statements 94-97, wherein the turfgrass is located in a plant growing environment selected from the group consisting of lawns, golf courses, athletic fields, sod farms, parks, cemeteries, non-agricultural fields, and combinations thereof.

Statement 99: The method according to any one of Statements 94-98, wherein contacting the one or more nutsedge weeds with the herbicidally effective amount of the herbicidal composition is operable to effectively control the one or more nutsedge weeds in the turfgrass following a single contacting.

Statement 100: The method according to Statement 97 or Statement 98, wherein post-emergent contact of the one or more nutsedge weeds in the turfgrass with the herbicidally effective amount of the herbicidal composition results in an 80% or greater reduction in the population of the one or more nutsedge weeds in the turfgrass, following a single contacting of the herbicidal composition with the one or more nutsedge weeds.

Statement 101: The method according to any one of Statements 94-100, further comprising: causing the application of an herbicidally effective amount of the herbicidal composition to the turfgrass comprising one or more nutsedge weeds such that the one or more nutsedge weeds in the turfgrass is contacted by an herbicidally effective amount of the herbicidal composition.

Statement 102: The method according to Statement 101, wherein causing the application of an herbicidally effective amount of the herbicidal composition to the turfgrass comprising the one or more nutsedge weeds is operable to effectively control the one or more nutsedge weeds in the turfgrass following a single application.

Statement 103: The method according to Statement 101 or Statement 102, wherein causing the application of an herbicidally effective amount of the herbicidal composition to the turfgrass comprising the one or more nutsedge weeds is results in an 80% or greater reduction in the population of the one or more nutsedge weeds in the turfgrass, following a single application of the herbicidal composition to the turfgrass.

Statement 104: The method according to Statement 101 or Statement 102, wherein causing the application of an herbicidally effective amount of the herbicidal composition to the turfgrass comprising the one or more nutsedge weeds is operable to cause an 80% or greater reduction in nutsedge population in the turfgrass following a single application of the herbicidal composition to the turfgrass.

Statement 105: The method according to Statement 101 or Statement 102, wherein causing the application of an herbicidally effective amount of the herbicidal composition to the turfgrass comprising the one or more nutsedge weeds is operable to cause an 80% or greater reduction in nutsedge population in the turfgrass when the herbicidal composition is applied to the turfgrass once per year.

Statement 106: The method according to Statement 101 or Statement 102, wherein causing the application of an herbicidally effective amount of the herbicidal composition to the turfgrass comprising the one or more nutsedge weeds is operable to cause an 80% or greater reduction in nutsedge population in the turfgrass when the herbicidal composition is applied to the turfgrass once per growing season.

Statement 107: The method according to any one of Statements 101-106, wherein the application of the herbicidal composition to the turfgrass is restricted to one application per year.

Statement 108: The method according to any one of Statements 101-106, wherein the application of the herbicidal composition to the turfgrass is restricted to one application per growing season.

Statement 109: The method according to any one of Statements 100-108, wherein the 80% or greater reduction in the population of the one or more nutsedge weeds in the turfgrass is achieved without the application of halosulfuron to the turfgrass.

Statement 110: The method according to any one of Statements 94-109, wherein halosulfuron is not applied to the turfgrass.

Statement 111: The method according to any one of Statements 94-110, further comprising: applying the herbicidal composition to the turfgrass once per year.

Statement 112: The method according to any one of Statements 94-110, further comprising: applying the herbicidal composition to the turfgrass once per growing season.

Statement 113: The method according to any one of Statements 100-112, further comprising: restricting the application of the herbicidal composition to the turfgrass to one application per growing season.

Statement 114: The method according to any one of Statements 94-113, wherein contacting the one or more nutsedge weeds comprises applying the herbicidal composition to the one or more nutsedge weeds or turfgrass comprising the one or more nutsedge weeds in an amount of from about 100 grams to about 4200 grams maleic hydrazide per hectare (ha) of turfgrass.

Statement 115: The method according to any one of Statements 94-113, wherein contacting the one or more nutsedge weeds comprises applying the herbicidal composition to the one or more nutsedge weeds or turfgrass comprising the one or more nutsedge weeds in an amount of from about 100 grams to about 7000 grams maleic hydrazide per hectare (ha) of turfgrass.

Statement 116: The method according to any one of Statements 94-113, wherein contacting the one or more nutsedge weeds comprises applying the herbicidal composition to the one or more nutsedge weeds or turfgrass comprising the one or more nutsedge weeds in an amount of from about 100 grams to about 3500 grams maleic hydrazide per hectare (ha) of turfgrass.

Statement 117: The method according to any one of Statements 94-113, wherein contacting the one or more nutsedge weeds comprises applying the herbicidal composition to the one or more nutsedge weeds or turfgrass comprising the one or more nutsedge weeds in an amount of from about 100 grams to about 1000 grams maleic hydrazide per hectare (ha) of turfgrass.

Statement 118: The method according to any one of Statements 94-113, wherein contacting the one or more nutsedge weeds comprises applying the herbicidal composition to the one or more nutsedge weeds or turfgrass comprising the one or more nutsedge weeds in an amount of from about 150 grams to about 1000 grams maleic hydrazide per hectare (ha) of turfgrass.

Statement 119: The method according to any one of Statements 94-113, wherein contacting the one or more nutsedge weeds comprises applying the herbicidal composition to the one or more nutsedge weeds or turfgrass comprising the one or more nutsedge weeds in an amount of from about 150 grams to about 3500 grams maleic hydrazide per hectare (ha) of turfgrass.

Statement 120: The method according to any one of Statements 94-113, wherein contacting the one or more nutsedge weeds comprises applying the herbicidal composition to the one or more nutsedge weeds or turfgrass comprising the one or more nutsedge weeds in an amount of from about 150 grams to about 500 grams maleic hydrazide per hectare (ha) of turfgrass.

Statement 121: The method according to any one of Statements 94-120, wherein contacting the one or more nutsedge weeds with the herbicidally effective amount of the herbicidal composition comprises applying the herbicidal composition to the turfgrass from about April to October or from about June to August when the turfgrass is located in the Northern Hemisphere.

Statement 122: The method according to any one of Statements 94-121, wherein contacting the one or more nutsedge weeds with the herbicidally effective amount of the herbicidal composition comprises causing the foliage, rhizome, or tuber of the one or more nutsedge weeds to be contacted by the herbicidal composition.

Statement 123: The method according to any one of Statements 94-122, wherein contacting the one or more nutsedge weeds with the herbicidally effective amount of the herbicidal composition comprises applying a liquid formulation comprising the herbicidal composition to the one or more nutsedge weeds or the turfgrass comprising the one or more nutsedge weeds.

Statement 124: The method according to any one of Statements 94-123, further comprising: spraying an herbicidally effective amount of the herbicidal composition or an herbicidally effective amount of a liquid formulation comprising the herbicidal composition according to any one of Statements 1-52 onto the one or more nutsedge weeds or the turfgrass comprising the one or more nutsedge weeds.

Statement 125: The method according to any one of Statements 94-124, wherein the turfgrass is located in a geographic location selected from the group consisting of the United States, Japan, Australia, and New Zealand.

Statement 126: The method according to any one of Statements 94-125, wherein the turfgrass comprises one or more cool season grasses.

Statement 127: The method according to any one of Statements 94-126, wherein the turfgrass comprises a turfgrass stand or one or more turfgrasses in a plant growing environment.

Statement 128: The method according to any one of Statements 94-127, further comprising: mowing the turfgrass.

Statement 129: The method according to any one of Statements 94-128, further comprising: using a mower to cut, crop, or trim the turfgrass.

Statement 130: The method according to Statement 128 or Statement 129, further comprising: applying the herbicidal composition or a liquid formulation comprising the herbicidal composition to the turfgrass within one week of the turfgrass being mowed.

Statement 131: The method according to Statement 128 or Statement 129, further comprising: applying the herbicidal composition or a liquid formulation comprising the herbicidal composition directly to the one or more nutsedge weeds in the turfgrass as a spot spray application within ten days of the of the turfgrass being mowed.

Statement 132: The method according to any one of Statements 94-131, wherein the turfgrass is a managed or manicured turfgrass located in selected from the group consisting of lawns, golf courses, athletic fields, sod farms, parks, and cemeteries.

Statement 133: The method according to any one of Statements 94-132, wherein the turfgrass comprises one or more selected from the group consisting of creeping bentgrass, perennial ryegrass, Kentucky bluegrass, tall fescue, fine fescue, and any combination thereof.

Statement 134: The method according to any one of Statements 94-132, wherein the turfgrass comprises one or more selected from the group consisting of zoysia grasses, Bermuda grasses, hybrid bermudagrass, St. Augustine grass, centipede grass, carpet grass, Bahiagrass, Kikuyu grass, buffalo grass, seashore paspalum, and any combinations thereof.

Statement 135: The method according to any one of Statements 94-132, wherein the turfgrass comprises one or more selected from the group consisting of zoysia grasses, Bermuda grasses, hybrid bermudagrass, St. Augustine grass, centipede grass, carpet grass, Bahiagrass, Kikuyu grass, buffalo grass, seashore paspalum, creeping bentgrass, perennial ryegrass, Kentucky bluegrass, tall fescue, fine fescue, and any combinations thereof.

Statement 136: The method according to any one of Statements 53-135, wherein the maleic hydrazide comprises maleic hydrazide potassium salt.

Statement 137: The method according to any one of Statements 53-136, wherein the maleic hydrazide comprises 1,2-dihydro-3,6-pyridazinedione monopotassium salt.

What is claimed is:

1. An herbicidal composition for the control of undesirable vegetation in a plant growing environment, the composition comprising:
an herbicidally effective amount of maleic hydrazide.

2. The herbicidal composition according to claim 1, wherein the composition excludes an ionic surfactant.

3. The herbicidal composition according to claim 1, wherein the composition excludes an ammoniated soap of fatty acid.

4. The herbicidal composition according to claim 1, wherein maleic hydrazide comprises from about 5% to about 30% by weight of the herbicidal composition, or from about 0.1% to about 85% by weight of the herbicidal composition, or from about 8% to about 25% by weight of the herbicidal composition, or from about 10% to about 22% by weight of the herbicidal composition, or from about 10% to about 12% by weight of the herbicidal composition, or from about 20% to about 23% by weight of the herbicidal composition.

5. The herbicidal composition according to claim 4, wherein the herbicidal composition is in the form of a formulation selected from the group consisting of an emulsifiable concentrate (EC), emulsion-in-water (EW), suspension concentrated (SC), suspoemulsion (SE), flowable concentrate (FL), wettable powder (WP), soluble liquid concentrate (SL), soluble powder (SP), ultra low volume (ULV) spray, microencapsulated or capsule suspension (CS), water dispersible granule (WDG), and any combination thereof.

6. The herbicidal composition according to claim 4, wherein the herbicidal composition is in the form of or otherwise capable of being formulated into a spot spray to treat or control the undesirable vegetation in the plant growing environment.

7. The composition according to claim 1, wherein the herbicidal composition comprises an herbicidal mixture of maleic hydrazide and one or more synthetic herbicides, wherein the ratio by weight of maleic hydrazide to the one or more synthetic herbicides is from about 4:1 to about 16:1, or from about 2:1 to about 32:1, or from about 4:1 to about 10:1, or from about 8:1 to about 32:1, or from about 8:1 to about 16:1, or from about 16:1 to about 32:1.

8. A method for controlling undesirable vegetation in a plant growing environment, the method comprising contacting the undesirable vegetation in the plant growing environment with an herbicidally effective amount of an herbicidal composition according to claim 1.

9. The method according to claim 8, wherein the undesirable vegetation is selected from the group consisting of one or more sedges or one or more plants belonging to the family Cyperaceae, Kyllinga or one or more plants belonging to the genus Kyllinga, and one or more nutsedge weeds or one or more plants belonging to the genus Cyperus.

10. The method according to claim 8, wherein the undesirable vegetation is one or more nutsedge weeds.

11. The method according to claim 10, wherein the one or more nutsedge weeds is selected from the group consisting of yellow nutsedge, purple nutsedge, and combinations thereof.

12. The method according to claim 10, wherein the undesirable vegetation is contacted post-emergence.

13. The method according to claim 12, wherein the plant growing environment is selected from the group consisting of lawns, golf courses, athletic fields, sod farms, parks, cemeteries, non-agricultural fields, plant nurseries, gravel pads, and roadways.

14. The method according to claim 13, wherein the plant growing environment comprises one or more turfgrasses or one or more ornamental plants.

15. The method according to claim 8,
wherein the undesirable vegetation is selected from the group consisting of one or more sedges or one or more plants belonging to the family Cyperaceae, Kyllinga or one or more plants belonging to the genus Kyllinga, and one or more nutsedge weeds or one or more plants belonging to the genus Cyperus; and
wherein post-emergent contact of the undesirable vegetation in the plant growing environment, comprising one or more turfgrasses or one or more ornamental plants, with the herbicidally effective amount of the herbicidal composition results in an 80% or greater reduction in the population of the undesirable vegetation in the plant growing environment, following a single application of the herbicidal composition to the plant growing environment.

16. The method according to claim 8, wherein the application of the herbicidal composition to the plant growing environment is restricted to one application per year, or is restricted to one application per growing season.

17. The method according to claim 8, wherein a 80% or greater reduction in the population of the undesirable vegetation in the plant growing environment is achieved without the application of halosulfuron to the plant growing environment.

18. The method according to claim 8, wherein the plant growing environment comprises one or more ornamental plants.

19. The method according to claim 8, wherein the plant growing environment is a turfgrass system, the turfgrass system comprising one or more turfgrasses or one or more stands of turfgrass.

20. The method according to claim 19, wherein the undesirable vegetation is one or more nutsedge weeds or one or more Kyllinga weeds, and wherein the turfgrass system is a managed or manicured turfgrass system located in selected from the group consisting of lawns, golf courses, athletic fields, sod farms, parks, and cemeteries.
